(19) United States
(12) Patent Application Publication
(10) Pub. No.: US 2020/0240767 A1
(43) Pub. Date: Jul. 30, 2020

(54) COORDINATE MEASUREMENT VALIDATION

(71) Applicant: ROLLS-ROYCE plc, London (GB)

(72) Inventors: Steven V. ALLEN, Bristol (GB); Roger OLDERSHAW, Bristol (GB)

(73) Assignee: ROLLS-ROYCE plc, London (GB)

(21) Appl. No.: 16/734,473

(22) Filed: Jan. 6, 2020

(30) Foreign Application Priority Data
Jan. 24, 2019 (GB) 1900960.4

(51) Int. Cl. G01B 11/03; G01B 11/00

(52) U.S. Cl. CPC G01B 11/03; G01B 11/005

(57) ABSTRACT

A method is provided for measuring and validating a dimensional feature of a component for compliance with a specification value for the feature. The method comprises the steps of: (a) measuring the dimensional feature of the component to a measurement level of accuracy using a co-ordinate measurement machine; (b) comparing the measurement level of accuracy of the measurement of the dimensional feature with a predetermined level of accuracy; (c) reformatting the measurement level of accuracy of the measurement of the dimensional feature to a level equal to the predetermined level of accuracy when the measurement level of accuracy is greater than the predetermined level of accuracy; and (d) comparing the reformatted measurement of the dimensional feature to the specification value for the dimensional feature, and validating the reformatted measurement when it is within a predetermined tolerance range for the specification value.

### CROSS-REFERENCE TO RELATED APPLICATIONS

This specification is based upon and claims the benefit of priority from UK Patent Application Number GB 1900960.4 filed on 24 Jan. 2019, the entire contents of which are incorporated herein by reference.

### BACKGROUND

### Technical Field

The present disclosure relates to a method of validating a measured dimensional feature of a component for compliance with a specification value for the feature, and a co-ordinate measurement machine and a computer-based system for use in such a method.

### Description of the Related Art

Co-ordinate measurement machines (CMMs) are used in manufacturing facilities to measure and inspect features of precision manufactured (e.g. machined) components.

A CMM is used to measure the actual size of a component, in comparison to the desired or designed shape, and is used for evaluation of metrological information such as: size, form, location, and position. These are generally referred to as dimensional features of a component. The actual size of a feature would generally be ascertained by probing the surface of a component at a number of discrete measuring points.

Typically a CMM comprises a probe head, which probes the component in a spatial direction, and a mechanism for allowing 3 axes of movement. The mechanism generally includes a displacement transducer, so that the absolute position of the probe head can be known at a high level of accuracy. The mechanism and probe head are connected to a controller, typically a processor, which implements an instruction set for ascertaining the dimensions of features of the component. Generally, a CMM is capable of measurement accuracy to 4-5 microns.

The use of a CMM enables components to be automatically inspected, measured, and have actual values recorded and reported. The resulting inspection process is therefore robust, repeatable, and reliable with only routine gauge inspection or calibration required to ensure consistency and compliance to measurement standards.

However, CMMs are unable to differentiate between features of a component, and the level of accuracy corresponding to those features as defined by the technical drawings. The level of accuracy defined by the technical drawings determines whether a feature of the component as measured conforms to a specification value. For most CMMs, measurement is taken to 4 decimal places and reported to 3 decimal places.

Whilst the level of accuracy (3 decimal places) is essential for some component features, the majority are dimensionally controlled within a tolerance band of 2 or fewer decimal places.

### For Example

| Drawing | | | Measured | Feature |
|---|---|---|---|---|
| Dimension | Max Size | Min Size | Result | Conformance |
| 10.42 +/− 0.10 mm | 10.520 | 10.320 | 10.520 | Conforming |
| | | | 10.521 | Non-conforming |
| | | | 10.319 | Non-conforming |
| | | | 10.320 | Conforming |

If the non-conforming entries had been measured to the appropriate level of accuracy, i.e. two decimal places, they would have been found as conforming.

There is a need then for CMMs and method employing CMMs which do not falsely report a component as non-conforming.

### SUMMARY

Accordingly, in a first aspect of the disclosure, there is provided a method of measuring and validating a dimensional feature of a component for compliance with a specification value for the feature, the method comprising the steps of:

(a) measuring the dimensional feature of the component to a measurement level of accuracy using a co-ordinate measurement machine;

(b) comparing the measurement level of accuracy of the measurement of the dimensional feature with a predetermined level of accuracy;

(c) reformatting the measurement level of accuracy of the measurement of the dimensional feature to a level equal to the predetermined level of accuracy when the measurement level of accuracy is greater than the predetermined level of accuracy; and

(d) comparing the reformatted measurement of the dimensional feature to the specification value for the dimensional feature, and validating the reformatted measurement when it is within a predetermined tolerance range for the specification value.

In a second aspect of the disclosure, there is provided a method of inspecting a component, the method comprising:

performing the method of the first aspect, to validate a dimensional feature of the component; and

passing the component when the reformatted measurement is validated or rejecting the component when the reformatted measurement is outside of the predetermined tolerance range.

In a third aspect of the disclosure, there is provided a co-ordinate measurement machine, configured to perform the method of the first or second aspects. For example, the co-ordinate measurement machine may be configured to perform the steps of: (a) measuring a dimensional feature of a component to a measurement level of accuracy; (b) comparing the measurement level of accuracy of the measurement of the dimensional feature with a predetermined level of accuracy; (c) reformatting the measurement level of accuracy of the measurement of the dimensional feature to a level equal to the predetermined level of accuracy when the measurement level of accuracy is greater than the predetermined level of accuracy; and (d) comparing the reformatted measurement of the dimensional feature to a specification value for the dimensional feature, and validating the reformatted measurement when it is within a predetermined tolerance range for the specification value.

In a fourth aspect of the disclosure, there is provided a computer-based system for validating a measured dimensional feature of a component for compliance with a specification value for the feature, the system being configured to perform the method of the first aspect and/or the second aspect.

In a fifth aspect of the disclosure, there is provided a computer program comprising code which, when the code is executed on a computer, causes the computer to perform the method of the first aspect and/or second aspect.

In a sixth aspect of the disclosure, there is provided a computer readable medium storing a computer program comprising code which, when the code is executed on a computer, causes the computer to perform the method of the first aspect and/or second aspect. For example, the computer-based system may be configured to perform the steps of: (a) receiving, from a co-ordinate measurement machine, a measurement of the dimensional feature of the component to a measurement level of accuracy; (b) comparing the measurement level of accuracy of the measurement of the dimensional feature with a predetermined level of accuracy; (c) reformatting the measurement level of accuracy of the measurement of the dimensional feature to a level equal to the predetermined level of accuracy when the measurement level of accuracy is greater than the predetermined level of accuracy; and (d) comparing the reformatted measurement of the dimensional feature to the specification value for the dimensional feature, and validating the reformatted measurement when it is within a predetermined tolerance range for the specification value. Similarly, the aforementioned code, when the code is executed on a computer, may cause the computer to perform the steps (a) to (d).

Advantageously, features of components which actually conform to the appropriate specification value will not erroneously be classified as non-conforming.

Optional features will now be set out. These are applicable singly or in any combination with any aspect of the disclosure.

The component may be a gas turbine engine component, such as a blade or vane.

Dimensional feature may refer to, for example, a location of a specific feature of the component or a distance between features of the component.

The method may further comprise the initial steps of:

identifying the component, and retrieving a plurality of dimensional features to be measured which are associated with the component;
identifying a corresponding predetermined level of accuracy for each of the plurality of dimensional features; and
performing steps (a)-(d) for each of the plurality of dimensional features, using the corresponding predetermined level of accuracy for each dimensional feature.

Identifying the component may be performed by using a scanner. Thus the computer-based system may include a scanner which is configured to identify the component. For example, the scanner may read a micro-dot part identity marker.

In step (c), the reformatting of the measurement level of accuracy of the measurement of the dimensional feature may be performed by either rounding up or rounding down the measurement of the dimensional feature.

The predetermined level of accuracy may be equal to an accuracy level of the predetermined tolerance range for the specification value.

The systems and methods of the above embodiments may be implemented in a computer system (in particular in computer hardware or in computer software) in addition to the structural components and user interactions described.

The term “computer-based system” includes the hardware, software and data storage devices for embodying a system or carrying out a method according to the above described embodiments. For example, a computer-based system may comprise a central processing unit (CPU), input means, output means, and data storage. Preferably the computer-based system has a monitor to provide a visual output display (for example in the design of the business process). The data storage may comprise RAM, disk drives or other computer readable media. The computer-based system may include a plurality of computing devices connected by a network and able to communicate with each other over that network.

The methods of the above embodiments may be provided as computer programs or as computer program products or computer readable media carrying a computer program which is arranged, when run on a computer, to perform the method(s) described above.

The term “computer readable media” includes, without limitation, any non-transitory medium or media which can be read and accessed directly by a computer or computer system. The media can include, but are not limited to, magnetic storage media such as floppy discs, hard disc storage media and magnetic tape; optical storage media such as optical discs or CD-ROMs; electrical storage media such as memory, including RAM, ROM and flash memory; and hybrids and combinations of the above such as magnetic/optical storage media.

The methods of the above embodiments may be provided as computer programs or as computer program products or computer readable media carrying a computer program which is arranged, when run on a computer, to perform the method(s) described above.

The term “computer readable media” includes, without limitation, any non-transitory medium or media which can be read and accessed directly by a computer or computer system. The media can include, but are not limited to, magnetic storage media such as floppy discs, hard disc storage media and magnetic tape; optical storage media such as optical discs or CD-ROMs; electrical storage media such as memory, including RAM, ROM and flash memory; and hybrids and combinations of the above such as magnetic/optical storage media.

### DESCRIPTION OF THE DRAWINGS

Embodiments of the disclosure will now be described by way of example with reference to the accompanying drawings in which:

FIG. 1 shows a co-ordinate measurement machine and connected controller; and

FIG. 2 shows a method of measuring and validating a dimensional feature of a component for compliance with a specification value for the feature.

Further aspects and embodiments will be apparent to those skilled in the art.

### DETAILED DESCRIPTION

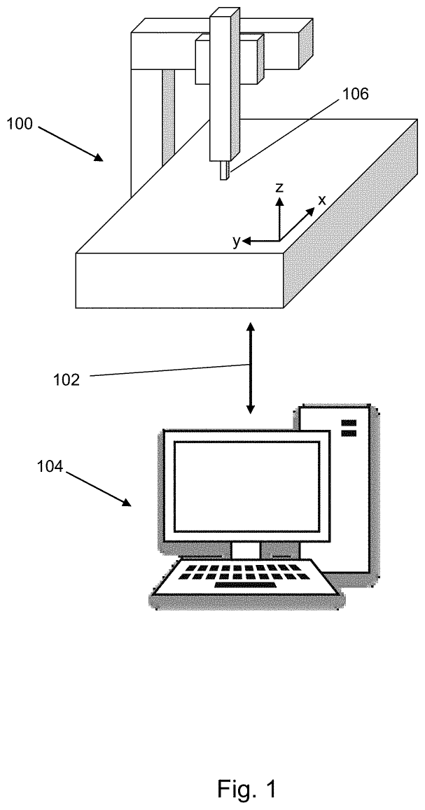

FIG. 1 shows a co-ordinate measurement machine (CMM) 100, connected via link 102 to a controller 104. The CMM is operable to move a probe 106 along three independent axes: x, y, and z. The controller 104 is configured to send movement commands to the CMM, and receive from the CMM corresponding dimensional feature data.

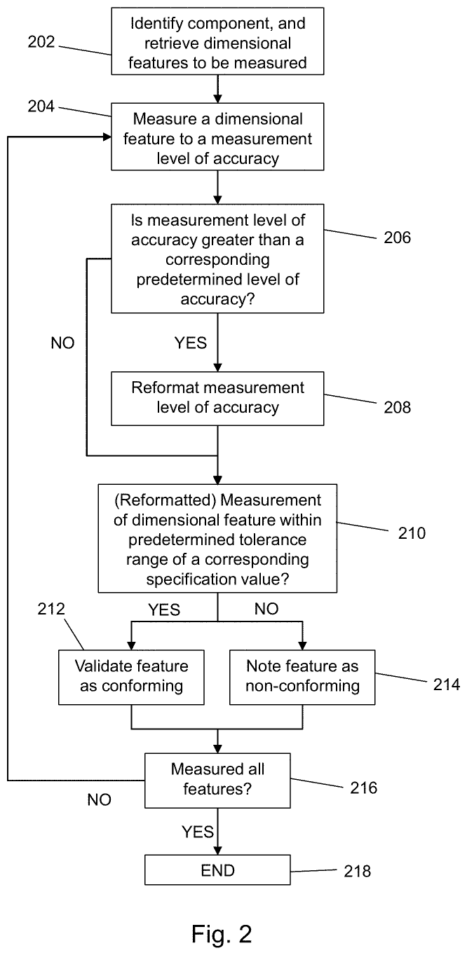

The dimensional feature data may be unprocessed, that is to say they may be to a level of accuracy set by firmware of the CMM. In such examples, the controller 104 may perform the processing discussed below in relation to FIG. 2. Alternatively, the CMM itself may perform the processing discussed below and may send dimensional feature data with a reformatted measurement level of accuracy to the controller 104.

FIG. 2 shows a method of measuring and validating a dimensional feature of a component, (e.g. a part of a gas turbine engine, such as a blade or vane), for compliance with a specification value for the feature. The method may be performed entirely by the CMM 100 above, or may be performed partly by the CMM and partly by the controller 104 or partly by the CMM and partly by a remote computer.

In a first step 202, which is optional, the component is identified and the CMM 100 or controller 104 retrieves a list of all dimensional features to be measured. The identification of the component may be performed by a scanner, connected to the CMM or controller. For example, the scanner may be an optical reader which reads a micro-dot part identity marker on the component. In step 204, a dimensional feature (which may be one of the list of dimensional features identified in step 202) is measured to a measurement level of accuracy which may be defined by the CMM. For example, the distance between two points on the component may be measured to an accuracy of three decimal places.

Next, in step 206, it is determined whether the measurement level of accuracy is greater than a corresponding predetermined level of accuracy for that dimensional feature. This can be performed by, for example, looking up a predetermined level of accuracy associated with the feature whose dimension is to be measured in a storage device.

If the measurement level of accuracy is greater than the corresponding predetermined level of accuracy (“YES”), the method moves to step 208 where the measurement level of accuracy is reformatted to a level equal to the predetermined level of accuracy. In this example, it may be that the predetermined level of accuracy is two decimal places. Therefore, in reformatting, the measurement level of accuracy may be rounded to two decimal places from three decimal places.

In the case where step 208 is performed, it is then determined if the reformatted measurement of the dimensional feature is within a predetermined tolerance range of a corresponding specification value (step 210). Alternatively, if the determination in step 206 was negative (“NO”), the method moves directly to step 210 and bypasses step 208 and the measurement used is the measurement as taken by the CMM (i.e. not reformatted).

If the determination is that the measurement of the dimensional feature is within the predetermined tolerance range (“YES”), the method proceeds to step 212 and the feature is validated as conforming to the design specification. Whereas, if the determination is that the measurement of the dimensional feature is not within the predetermined tolerance range (“NO”), the method proceeds to step 214 and the feature is noted as non-conforming to the design specification.

Next, in both cases, the method proceeds to step 216, where a determination is made as to whether all features in the list (see step 202) have been measured. If so, (“YES”), the method moves to step 218 and ends. Otherwise, the method returns to step 204 for the next feature to be measured. Step 216 may be ignored when there is only a single dimensional feature to be measured, and in such cases the method will proceed directly from either step 212 or 214 to step 218.

Having undergone measurement and validation, the subject component may then be passed for subsequent use (in the case where all features a validated as conforming), or may be rejected (in the case where one or more features are not validated). For example, a rejected component may undergo remedial processing and then be sent for re-measurement and re-validation.

While the disclosure has been described in conjunction with the exemplary embodiments described above, many equivalent modifications and variations will be apparent to those skilled in the art when given this disclosure. Accordingly, the exemplary embodiments of the disclosure set forth above are considered to be illustrative and not limiting. Various changes to the described embodiments may be made without departing from the spirit and scope of the disclosure.

1. A method of measuring and validating a dimensional feature of a component for compliance with a specification value for the feature, the method comprising the steps of:
(a) measuring the dimensional feature of the component to a measurement level of accuracy using a co-ordinate measurement machine;
(b) comparing the measurement level of accuracy of the measurement of the dimensional feature with a predetermined level of accuracy;
(c) reformatting measurement level of accuracy of the measurement of the dimensional feature to a level equal to the predetermined level of accuracy when the measurement level of accuracy is greater than the predetermined level of accuracy; and
(d) comparing the reformatted measurement of the dimensional feature to the specification value for the dimensional feature, and validating the reformatted measurement when it is within a predetermined tolerance range for the specification value.

2. The method of claim 1, further comprising the initial steps of:
identifying the component, and retrieving a plurality of dimensional features to be measured which are associated with the component;
identifying a corresponding predetermined level of accuracy for each of the plurality of dimensional features; and
performing steps (a)-(d) for each of the plurality of dimensional features, using the corresponding predetermined level of accuracy for each dimensional feature.

3. The method of claim 2, wherein identifying the component is performed using a scanner.

4. The method of claim 1, wherein in step (c), the reformatting of the measurement level of accuracy of the measurement of the dimensional feature is performed by either rounding up or rounding down the measurement of the dimensional feature.

5. The method of claim 1, wherein the predetermined level of accuracy is equal to an accuracy level of the predetermined tolerance range for the specification value.

6. A method of inspecting a component, the method comprising the steps of: performing the method of claim 1, to validate a dimensional feature of the component; and
passing the component when the reformatted measurement is validated or rejecting the component when the reformatted measurement is outside of the predetermined tolerance range.

7. The method of claim 1, wherein the component is a gas turbine engine component.

8. A co-ordinate measurement machine, configured to perform the steps of:
(a) measuring a dimensional feature of a component to a measurement level of accuracy;
(b) comparing the measurement level of accuracy of the measurement of the dimensional feature with a predetermined level of accuracy;
(c) reformatting the measurement level of accuracy of the measurement of the dimensional feature to a level equal to the predetermined level of accuracy when the measurement level of accuracy is greater than the predetermined level of accuracy; and
(d) comparing the reformatted measurement of the dimensional feature to a specification value for the dimensional feature, and validating the reformatted measurement when it is within a predetermined tolerance range for the specification value.

9. The co-ordinate measurement machine of claim 8, further configured to perform the steps of:
identifying the component, and retrieving a plurality of dimensional features to be measured which are associated with the component;
identifying a corresponding predetermined level of accuracy for each of the plurality of dimensional features; and
performing steps (a)-(d) for each of the plurality of dimensional features, using the corresponding predetermined level of accuracy for each dimensional feature.

10. The co-ordinate measurement machine of claim 9, further comprising a scanner, configured to identify the component.

11. The co-ordinate measurement machine of claim 8, wherein in step (c) the reformatting of the measurement level of accuracy of the measurement of the dimensional feature is performed by either rounding up or rounding down the measurement of the dimensional feature.

12. The co-ordinate measurement machine of claim 8, wherein the predetermined level of accuracy is equal to an accuracy level of the predetermined tolerance range for the specification value.

13. A computer-based system for validating a measured dimensional feature of a component for compliance with a specification value for the feature, the system being configured to perform the steps of:
(a) receiving, from a co-ordinate measurement machine, a measurement of the dimensional feature of the component to a measurement level of accuracy;
(b) comparing the measurement level of accuracy of the measurement of the dimensional feature with a predetermined level of accuracy;
(c) reformatting the measurement level of accuracy of the measurement of the dimensional feature to a level equal to the predetermined level of accuracy when the measurement level of accuracy is greater than the predetermined level of accuracy; and
(d) comparing the reformatted measurement of the dimensional feature to the specification value for the dimensional feature, and validating the reformatted measurement when it is within a predetermined tolerance range for the specification value.

14. The system of claim 13, further configured to perform the steps of:
identifying the component, and retrieving a plurality of dimensional features to be measured which are associated with the component;
identifying a corresponding predetermined level of accuracy for each of the plurality of dimensional features; and
performing steps (a)-(d) for each of the plurality of dimensional features, using the corresponding predetermined level of accuracy for each dimensional feature.

15. The system of claim 14, wherein system further includes a scanner, which is configured to identify the component.

16. The system of claim 13, wherein in step (c) the reformatting of the measurement level of accuracy of the measurement of the dimensional feature is performed by either rounding up or rounding down the measurement of the dimensional feature.

17. The system of claim 13, wherein the predetermined level of accuracy is equal to an accuracy level of the predetermined tolerance range for the specification value.

18. A computer program comprising code which, when the code is executed on a computer, causes the computer to perform the method of claim 1.
